(19) United States
(12) Patent Application Publication
(10) Pub. No.: US 2004/0088831 A1
(43) Pub. Date: May 13, 2004

(54) Holder for securing objects

(75) Inventor: Erich Mekyska, Pforzheim (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Interpen

(21) Appl. No.: 10/361,546

(22) Filed: Feb. 10, 2003

Related U.S. Application Data
(60) Provisional application No. 60/425,505, filed on Nov. 12, 2002.

(30) Foreign Application Priority Data
Nov. 8, 2002 (EP) 02024853.0

(51) Int. Cl. B43K 25/00

(52) U.S. Cl. 24/11 PP

(57) ABSTRACT

Disclosed is a holding device. The holding device includes two opposing clamping surfaces which are spaced apart from each other and which are held by a carrier body or which form part of the carrier body.

The invention relates to a holding device for spherical and flat objects, comprising two opposing clamping surfaces which are spaced apart from each other and which are held by a carrier body or which form part of the carrier body.

A multitude of holding devices for spherical or flat objects are known, but as a rule these are heavy and cumbersome holding devices which require a lot of space or which can accommodate objects only loosely. However, it may be necessary to hold objects in an unfavourable position, for example in a vertical position, without the objects to be accommodated being able to fall out. For such applications, the holding device should as far as possible be universally useable and for example be suitable for accepting small items, tubes, toothbrushes, writing implements, sheets of paper and the like. In most cases there is a lack of suitable space or a suitable storage place for providing adequate quantities of the necessary utensils or objects so that they are easily accessible to everyone. Even in the age of EDP technology, for example, a paper holding device and if need be a writing implement holding device and indispensable. In particular, in locations where short notes are required, such as for example in domestic situations or office premises near a telephone, a fax machine or the like, a holding device can prove very useful. Holding devices for this or that object are for example known, which holding devices, for example for holding writing devices, comprise loops or holes in a carrier body. However, these holding devices are associated with a basic disadvantage in that mostly they are only designed for a particular size or a particular diameter of the object. If objects of a different size are used, these holding devices no longer fit, i.e. the object simply lies in the holding device without being held properly. The situation is similar in the case of writing paper required, which in most cases is not readily available; consequently, notes are written into the margin of a newspaper or the like. To the extent that paper holders are known, they are limited to surrounding a block, to adhesive notepaper or memo-pad boxes; however, all of these have to rest on a flat surface. When an almost perpendicular type of attachment is chosen, for example only magnetic clamps on a metal backing can be used, which are however only suitable for relatively light-weight objects such as for example an individual sheet of paper.

It is thus the object of the invention to provide a holding device for flat objects which objects can easily be inserted and held by jamming action, and can subsequently just as easily be removed.

According to the invention, this object is met in that at least one clamping surface comprises retention means in the form of a flat basic body which incorporates several formed lips. The object according to the invention thus comprises a carrier body which comprises two opposing clamping surfaces which are spaced apart from each other, said clamping surfaces comprising retention means in the form of a flat basic body with several formed lips. This makes it possible, in an advantageous way, for the two clamping surfaces to be arranged so as to be spaced apart by a larger distance, with the length of the lips being such that the clearance between the clamping surfaces is almost completely covered by the lips. As a result of this, extremely flat objects such as for example an individual sheet of paper or a larger stack of paper or a single cheque identification card and significantly thicker objects can be accommodated in one and the same holding device. In this design, the formed lips bridge the clearance between the two clamping surfaces and enable the lips to directly rest against the object to be accommodated, thus providing safe holding. In this arrangement, the object can be attached either in a horizontal or a vertical position or in a position inclined to vertical. The holding device is thus eminently suitable for accommodating maps or drawings as well as tubes, cheque identification cards, calling cards or other flat objects which if need be can also be arranged in a stack. Advantageously, the lips are connected in a single piece with the basic body which accommodates them, so that when an elastic material is used there is sufficient inherent elasticity in order to be able to accept the respective objects. The lips which have been formed to the basic body in one piece can be arranged so as to be parallel, undulating or zigzagging, with the spacing to adjacent lips remaining the same.

According to the invention, the lips are arranged perpendicular or at an angle of 20 to 50 degrees relative to the basic body, with the lips comprising uninterrupted or interrupted front edges. Thus, the elastic retention means comprises a flat body with several lips formed in one piece and extending parallel to each other, which are arranged at a particular angle and which thus facilitate the insertion of objects, and provide adequate resistance so that the objects cannot fall out. The outer edges of the lips come to rest against the objects so that they are held, quasi by jamming action. This holding device provides a particular advantage if a stack of several sheets of paper is inserted between the clamping surfaces, because due to multiple contact established by the lips or front edges which are aligned parallel in relation to each other, a single sheet can be removed from the existing stack of loosely stacked paper, without the complete stack or further papers being pulled out of the holding device. The lips can be arranged so as to be inclined or preferably so as to extend across the direction of insertion, with the angle of inclination of the lips at the opposing retention means supplementing itself to the extent that the ends of the lips either touch each other or protrude into the respective opposing clearance space. This ensures that the lips come to rest fully against the object to be accommodated, for example a stack of paper or a newspaper or a map. As a result of the objects inserted being relatively light in weight, the contact force of the elastic lips provides a safe hold with the above-mentioned advantages. Several flat objects arranged in a stack can be accommodated and subsequently removed individually, either in downward direction or to the side at an angle, without the remaining objects being removed as well at the same time, because they are kept reliably and safely in place by the jamming action of the lips. This effect is due to the fact that when a single object, for example a sheet of paper, is withdrawn, always a considerable number of lips act upon the remaining stack of paper, so that the contact force prevents any object from slipping out. The front edge of the lips can be uninterrupted or interrupted if required, so that the inherent elasticity is further improved. To the extent that there are gaps, these gaps can be arranged so as to be offset from lip to lip.

A further embodiment of the invention provides for the retention means with the lips to be attached to the clamping surfaces either flush or in an indentation, for example to be glued on. As a result of this measure, almost the entire clearance between the clamping surfaces is available for accommodating objects.

A further particular embodiment of the invention provides for the carrier body to be provided on the one hand for accommodating the retention means and on the other hand for accommodating a clamping device for accommodating and holding round or angular objects. By providing a combination, according to the invention, of a holding device for flat objects and a clamping device for accommodating round or angular objects, an advantageous combination results which for example can at the same time be used for accommodating a toothbrush and a toothpaste tube, or in particular also for accommodating a writing device and the paper required for it. The combination, according to the invention, of a writing device holder and a paper holder thus provides a constructional unit which can be attached in a vertical or horizontal position, for example using an adhesive pad.

A further embodiment of the invention provides for the carrier body to comprise an upper cover plate and a lower bottom part, with the two parts being held together by clamping means, wherein the bottom part and/or the cover plate comprise a recess which after assembly form a slot guide, with the two clamping surfaces being formed within said slot guide. A stack of paper can thus be inserted into the slot guide where it is held in any desired position by the retention means, while a writing device is held by the further clamping device.

A further embodiment of the invention provides for the cover plate and the bottom part to be held together by hook-shaped projections or pins, arranged on the margin, which projections lock into place in corresponding recesses or drill holes. In this arrangement, the carrier plate of the clamping device and the carrier body for accommodating the clamping device or the holding device, can be made either in a single part or if need be in two parts. It is imaginable that either the cover plate or the bottom part extends only partly over the corresponding counterpart. For example, the cover plate can be attached in a rectangular aperture of the bottom part, or the bottom part can be attached in a corresponding aperture of the cover plate, so that it is not absolutely necessary to use two components which are of the same size and which are approximately mirror-symmetrical. If the carrier body or the carrier plate is a two-part variant, accommodation of the carrier plate in the carrier body is for example within an opening, in that the carrier plate can be glued in or, if need be, jammed in. In this way it is possible to create an elegantly shaped variant, for example a holding device for a writing device and for a paper pad, with said holding device being extremely useful and being able to be attached in any position, and furthermore making it possible to remove the writing device with one hand and, if need be, to remove a single sheet from the paper holder, either before or after this sheet is written on.

A further embodiment of the invention provides for the clamping device to be designed for accommodating and holding round or angular objects, for example writing devices, tools, toothbrushes, wet shavers, nail files and the like, with said clamping device comprising a carrier plate with two clamping elements, of which at least one clamping element is held so as to be slidable and spring-loaded, and wherein the carrier plate and the clamping element, of which there is at least one, comprise corresponding guide means. Due to the clamping jaw, of which there is at least one, being movably arranged on the carrier body or on the carrier plate and being guided under spring tension, they can be compressed and in a home position they can touch each other, at least in the lower region, so that both clamping elements come to rest in a defined position relative to each other. In this arrangement, the area of the clamping jaws is relatively large in relation to the carrier plate or the carrier body so that either a large full-surface support option or a large concave-surface support option with a margin spaced at a distance is achieved, which causes the clamping jaws to slide properly on the carrier plate or on the carrier body. As an alternative option, the two clamping elements or clamping jaws are arranged so as to be slidable within a guide. As a result of the slide guidance, the writing implements or similar utensils to be accommodated can be accommodated by simply pressing them in, and they can be removed just as easily. Preferably, the writing-implement holder comprises two clamping jaws which are mutually opposed, and which in the home position, at least in the lower region, can partly touch each other so that the clamping jaws form a small gap in the upper region of insertion so as to facilitate the insertion of the object. The guide arrangement for the clamping jaws comprises a base of the guide and/or a raised guide surface, for example a bulge on the carrier plate of if need be the carrier body, wherein the base of the guide engages at least one groove or one slot in the carrier plate and wherein the base of the guide comprises at least two retention claws which are aligned in opposite directions, with said retention claws gripping the groove or the slot from behind. As an alternative, the base of the guide can comprise a sliding shoe, a triangular guide or a dovetail guide, with the groove or the slot comprising a corresponding accommodation surface. The above-mentioned measures prevent the base of the guide of the clamping jaws from being able to slide out of the carrier plate or the carrier body; in this case the connection would be lost. As an alternative, the guide arrangement of the clamping jaws can additionally comprise at least one drill hole in the transverse stay or in the base of the guide in order to accommodate at least one pin held in the carrier plate, on which the clamping jaw, of which there is at least one, slides to and fro. This alternative embodiment supports the ease of operation of the clamping jaws by a pin which is arranged at a certain distance from the guide surface of the carrier plate or of the carrier body.

To facilitate insertion of writing devices and for improved handling, the clamping jaws comprise two interior surfaces which are opposite each other and which are designed to be mirror-symmetrical, with said interior surfaces being bevelled in the direction of movement of the object, and in the middle region are of round, angular or elliptic shape. In the transition area between the bevelled surface and the shaped area there is a narrowing which quasi enables the writing device to be encompassed. As already explained, the bevel provided on the clamping jaws facilitates inserting and putting into place the objects, while the narrowing requires that the clamping jaws are slightly pushed apart for insertion, so that after the clamping jaws have closed up, the round, triangular or elliptic region comes to rest against the object, for example a writing device, thus preventing the object from sliding out. In this arrangement the existing narrowing can be spaced apart; alternatively it can cause the two opposing clamping jaws to rest against the object.

In order to achieve even contact force onto the clamping jaws and thus onto the writing devices, at least one spring is used for spring tensioning, with said spring being arranged in a guide between the brackets or the bases of the guides, and the supporting bracket or the supporting rim of the carrier body.

In order to provide further improved retention, the inside of the clamping jaws can comprise ribbing, roughening or a rubber coating. In this arrangement, the carrier plate or the carrier body can be round or if need be angular in shape with the carrier plate being accommodated in a corresponding opening of the carrier body. Apart from this, the shape of the carrier body can be designed to be independent and purposeful.

Below, the holding device according to the invention is explained in more detail by means of the figures.

The following are shown:

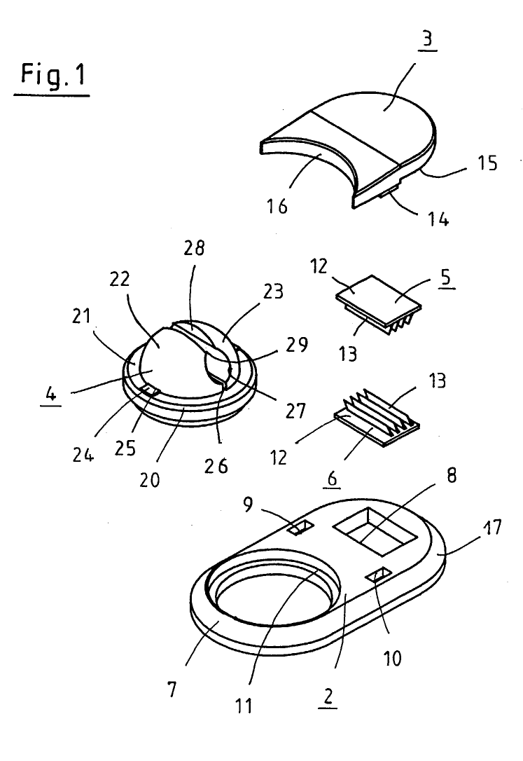

FIG. 1 an exploration drawing of the holding device according to the invention with a clamping device;

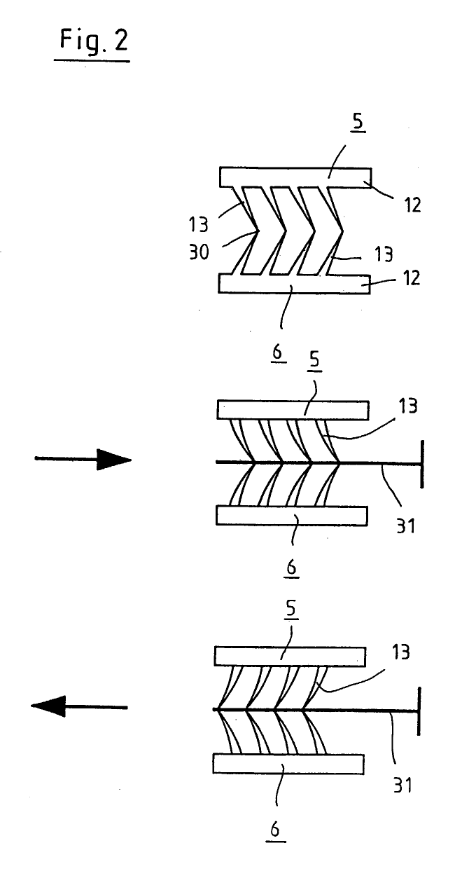

FIG. 2 three partial views diagrammatically depicting the operation of the retention means; and

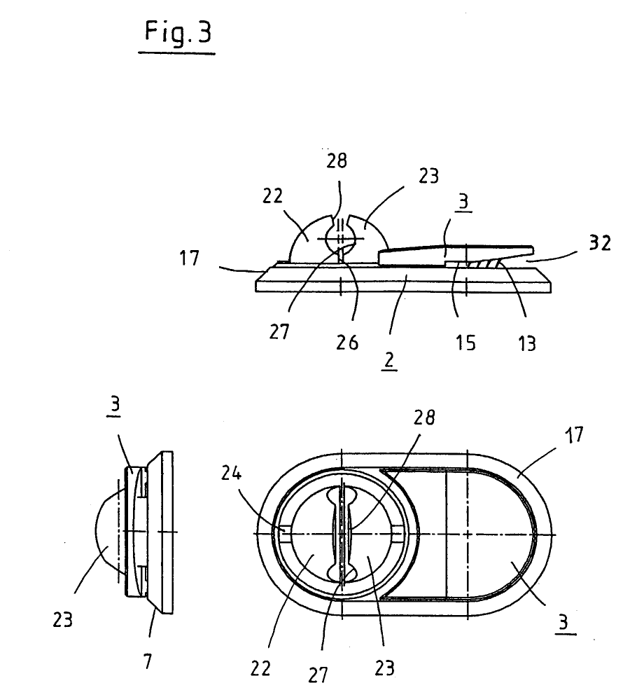

FIG. 3 the holding device according to FIG. 1 in three views.

FIG. 1 shows a perspective view of a holding device 1 according to the invention, comprising a bottom plate 17 with a top cover plate 3, a clamping device 4 as well as two corresponding retention means 5, 6 for holding individual or several objects (not shown).

In this arrangement, the carrier body 2 is formed by the bottom plate 17 and the top cover plate 3, the latter partly covering the bottom plate 17.

The bottom plate 17 is elongated and flat in shape, with a rounding 7 at each end. Furthermore, the bottom plate 17 comprises a rectangular recess 8 as well as two apertures 9, 10 and a round opening 11 which is stepped. The opening 11 corresponds to the clamping device 4 such that said clamping device 4 can be accommodated by being glued in or if need be by being jammed in. A lower retention means 6 in the form of an elastic body is inserted into the recess 8 and, if need be, said lower retention means 6 is jammed in or glued in. The holding means 6 is for example made from an elastic plastic with a rectangular base body 12 to which several lips 13 extending parallel to each other have been formed, with said lips 13 being arranged at an angle relative to the basic body 12. The upper retention means 5 is mirror-symmetrical, with the lips 13 either being able to touch the lower lips 13 of the retention means 6, or by being shaped respectively, coming to rest between the individual lips 13. The retention means 5 is jammed into a corresponding recess in the upper cover plate 3 or if need be is glued on, with said recess matching the shape of the carrier body 2, and with two retention claws 14 engages the recesses 9, 10 of the carrier body 2 so as to lock into place. The cover plate 3 with its retention means 5 as well as the bottom plate 17 with the retention means 6 together form the holding device 1 for flat objects, for example a stack of paper, with a slot guide being provided for inserting the stack of paper between the bottom plate 17 and the upper cover plate 3 by an existing set-off 15 in the cover plate 3. The cover plate 3 matches the form of the writing device holder 4 to the extent that a rounding 16 comes to rest against the writing device holder 4.

Essentially, the clamping device 4 comprises a lower carrier plate 20 which can for example comprise an upper and a lower part of the plate and can comprise a gradation which extends so as to correspond with the gradation of the opening 11 of the bottom plate 17. Arranged on the top 21 of the clamping device 4 are two clamping elements 22, 23 whose underside slidably rests against the top 21 either over the full surface or in the marginal area only. In order to achieve an improved guide arrangement, a bulge 24, formed in the region of the displacement path of the clamping elements 22, 23, is arranged on the top 21. To this effect, the clamping elements 22, 23 comprise a corresponding aperture 25. Together, the clamping elements 22, 23 form a hemisphere, i.e. individually each element forms a quadrant, with the interior surfaces 26 facing each other, being of mirror-symmetric shape comprising a rounded middle region 27, an upper bevel 28 as well as a narrowing 29. The clamping elements 22, 23 are guided in a guide arrangement (not shown) of the carrier body 20 and are pretensioned by a spring (not shown) arranged in the carrier plate 20 such that said clamping elements 22, 23 assume a middle position on said carrier plate 20. Due to the slidability, for example a writing device can be pushed into the bevel 28, so that the two clamping elements 22, 23 slide apart and the rounded middle region 27 comes to rest around the writing device, thus being able to safely and firmly jam it. As a result of the clamping elements 22, 23 or at least one clamping element 22 or 23 being able to slide on the top 21 of the carrier body 20, it is thus possible for writing devices of various diameters to be safely accommodated.

The upper diagram in FIG. 2 shows the two opposing retention means 5, 6 with the front edges 30 of their lips 13 touching. Alternatively, the front edges can be situated between the lips 13 so as to be offset. The middle diagram also shows the arrangement of the retention means 5, 6, with a single sheet of paper 31 inserted between the lips 13, thus slightly pretensioning the lips 13 in the direction of movement. The lower diagram also shows the two retention means 5, 6 with their lips 13 during withdrawal of a single sheet of paper 31. During this process, the inclination of the lips 13 is displaced due to the inherent elasticity so that safe guidance and holding is provided until the sheet of paper 31 is completely removed. In case several sheets of paper 31 were previously inserted between the retention means 5, 6, there is the option of withdrawing an upper or lower single sheet of paper 31, with the contacting lips 13 being pressed in the direction of movement.

FIG. 3 shows three views of the holding device according to the invention after assembly. The holding device 1 comprises a carrier body 2 which is formed by a bottom plate 17 and a cover plate 3. The cover plate 3 comprises a set-off 15 so that the retention means 5, 6 can be accommodated on the one hand in the cover plate 3 and on the other hand in the bottom plate 17 in a lower-lying recess 8. As a result of the set-off 15, the two parts of the carrier body 2 are spaced apart such that, for example, flat objects can be inserted into the slot guide 32 and can be accommodated and held by the retention means 5, 6 or by the formed lips 13. Furthermore, the carrier body 2 comprises a clamping device 4 which comprises a carrier plate 20 with two clamping elements 22, 23 between which round or angular objects, for example writing devices, can be accommodated. The two clamping elements 22, 23, which are quadrants, are arranged on the carrier plate 20 so as to be slidable, with a guide for stabilising the movement direction being provided by a bulge 24, said guide coming to rest in an aperture 25 of the clamping elements 22, 23. The interior surfaces of the clamping elements 22, 23, which interior surfaces face each other, comprise an approximately round middle region 27, a narrowing 29 as well as on the upper edge a bevel 28 for improved insertion of the objects to be accommodated. At least one of the clamping elements 22, 23 is arranged on the carrier plate 20 so as to be slidable, so that during insertion of the object, the clamping elements are pushed apart as a result of the force expended, and after completion of the insertion and after return of the moved clamping elements 22, 23 the formed middle region 27 comes to rest around the object. The holding device 1 according to the invention, together with the clamping device 4, provides an elegant and useful combination, for example for accommodating a writing device or individual sheets of paper. Other objects, such as toothbrushes, toothpaste tubes, writing implements, maps and the like, can also be accommodated. To this purpose, the holding device 1 with clamping device 4 can for example be glued onto a flat table surface or wall surface by means of adhesive pads, so that attachment is possible wherever the device is used.

### LIST OF REFERENCE NUMBERS

1 Holding device

2 Carrier body

3 Cover plate

4 Clamping device

5 Retention means

6 Retention means

7 Rounding

8 Recess

9 Aperture

10 Aperture

11 Opening

12 Basic body

13 Lip

14 Retention claw

15 Set-off

16 Rounding

17 Bottom plate

20 Carrier plate

21 Top

22 Clamping element

23 Clamping element

24 Bulge

25 Aperture

26 Interior surface

27 Middle region

28 Bevel

29 Narrowing

30 Front edge

31 Sheet of paper

32 Slot guide

1. A holding device (1) for spherical and flat objects, comprising two opposing clamping surfaces which are spaced apart from each other and which are held by a carrier body (2) or which form part of the carrier body (2),
characterised in that
at least one clamping surface comprises retention means (5, 6) in the form of a flat basic body (12) which incorporates several formed lips (13).

2. The holding device according to claim 1,
characterised in that
the lips (13) are connected in a single piece with the basic body (12)

3. The holding device according to claim 1 or 2,
characterised in that
the lips (13) are arranged so as to be parallel, undulating or zigzagging, with the spacing to adjacent lips (13) remaining the same.

4. The holding device according to any one of claims 1, 2 or 3,
characterised in that
the lips (13) are arranged perpendicular or at an angle of 20 to 50 degrees relative to the basic body (12), with the lips (13) comprising uninterrupted or interrupted front edges (30).

5. The holding device according to one or several of claims 1 to 4,
characterised in that
the lips (13) are arranged so as to be inclined or so as to extend across the direction of insertion.

6. The holding device according to one or several of claims 1 to 5,
characterised in that
the angle of inclination of the lips (13) at the opposing retention means (5, 6) supplements itself to the extent that the front edges (30) of the lips (13) touch each other or protrude into the clearance spaces.

7. The holding device according to one or several of claims 1 to 6,
characterised in that
the retention means (5, 6) are attached to the clamping surfaces either flush or in an indentation, for example glued on.

8. The holding device according to one or several of claims 1 to 7,
characterised in that
the carrier body (2) is provided on the one hand for accommodating the retention means (5, 6) and on the other hand for accommodating a clamping device (4) for accommodating and holding round or angular objects.

9. The holding device according to one or several of claims 1 to 8,
characterised in that
the carrier body (2) comprises an upper cover plate (3) and a lower bottom part (17) which are held together by clamping means, wherein the bottom part (17) and/or the cover plate (3) comprise/s a recess which after assembly form/s a slot guide, with the two clamping surfaces being formed within said slot guide.

10. The holding device according to one or several of claims 1 to 9,
characterised in that
the cover plate (3) and the bottom part (17) are held together by hook-shaped projections or pins, arranged on the margin, which projections lock into place in corresponding recesses (9, 10) or drill holes.

11. The holding device according to one or several of claims 1 to 10,
characterised in that
the clamping device (4) is designed for accommodating and holding round or angular objects, for example writing devices, tools, toothbrushes, wet shavers, nail files and the like, with said clamping device (4) comprising a carrier plate (20) with two clamping elements (22, 23), of which at least one clamping element (22, 23) is held so as to be slidable and spring-loaded, and wherein the carrier plate (20) and the clamping element (22, 23), of which there is at least one, comprise corresponding guide means.

12. The holding device according to one or several of claims 1 to 11,
characterised in that
the carrier plate (20) and the carrier body (2) are constructed in a single piece or in two pieces.

13. The holding device according to one or several of claims 1 to 12,
characterised in that
the carrier plate (20) of the clamping device (4) is accommodated in an opening (11) by being glued in or jammed in.

14. The holding device according to one or several of claims 1 to 13,
characterised in that
at least two clamping jaws (22, 23) are arranged on the carrier plate (20) of the clamping device (4), with said clamping jaws (22, 23) opposing each other and in a home position touching each other partly at least in the lower region, with at least one of said clamping jaws (22, 23) being slidably held under spring tension in at least one guide.

15. The holding device according to one or several of claims 1 to 14,
characterised in that
the guide arrangement for the clamping jaws (22, 23) comprises a base of the guide and/or comprises a raised guide surface, for example a bulge (24) on the carrier plate (20), wherein the base of the guide engages at least one groove or one slot in the carrier plate (20), and wherein the base of the guide comprises at least two retention claws which are aligned in opposite directions, with said retention claws gripping the groove or the slot from behind, or in that the base of the guide comprises a sliding shoe, a triangular guide or a dovetail guide, with the groove or the slot comprising a corresponding accommodation surface.

16. The holding device according to one or several of claims 1 to 15,
characterised in that
the guide arrangement of the clamping jaws (22, 23) additionally comprises at least one drill hole in the transverse stay or in the base of the guide, and at least one pin held in the carrier plate (20), on which the clamping jaw (22, 23), of which there is at least one, slides to and fro.

17. The holding device according to one or several of claims 1 to 16,
characterised in that
the clamping jaws (22, 23) comprise two interior surfaces (26) which are opposite each other and which are designed to be mirror-symmetrical, with said interior surfaces (26) comprising a bevel (28) in the direction of movement of the object to be accommodated, and in the middle region (27) being round, angular or elliptic shape, wherein in the transition area between the bevelled surface and the shaped area there is a narrowing (29).

18. The holding device according to one or several of claims 1 to 16,
characterised in that
at least one spring is provided for spring tensioning, with said spring being arranged in a guide between the brackets or the bases of the guide, and a supporting bracket or the supporting rim of the carrier plate (20).
